(19) United States
(12) Patent Application Publication
(10) Pub. No.: US 2005/0015409 A1
(43) Pub. Date: Jan. 20, 2005

(54) Techniques for performing operations on migrated files without recalling data

(75) Inventors: Wen Cheng, San Jose, CA (US); Rini Kaushik, Sunnyvale, CA (US); Bob Grewal, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA (US)

(21) Appl. No.: 10/857,176

(22) Filed: May 28, 2004

Related U.S. Application Data
(60) Provisional application No. 60/474,333, filed on May 30, 2003.

(51) Int. Cl. G06F 7/00

(52) U.S. Cl. 707/200

(57) ABSTRACT

Techniques for performing operations on migrated files without triggering a recall of the migrated data. For example, embodiments of the present invention can perform a copy, move, or delete operation on a migrated file without recalling the migrated data associated with the file.

### CROSS-REFERENCES TO RELATED APPLICATIONS

The present application claims the benefit of U.S. Provisional Patent Application No. 60/474,333 filed May 30, 2003 (Attorney Docket No. 21154-00110US), the entire contents of which are herein incorporated by reference for all purposes.

### BACKGROUND OF THE INVENTION

The present invention relates to data storage and management, and more particularly to techniques for performing operations on files without performing recalls.

Data storage demands have grown dramatically in recent times as an increasing amount of data is stored in digital form. These increasing storage demands have given rise to heterogeneous and complex storage environments comprising storage systems and devices with different cost, capacity, bandwidth, and other performance characteristics. Due to their heterogeneous nature, managing storage of data in such environments is a complex and costly task.

Several solutions have been designed to reduce costs associated with data storage management and to make efficient use of available storage resources. For example, Hierarchical Storage Management (HSM) storage applications, Information Lifecycle Management (ILM) applications, etc. are able to automatically and transparently migrate data along a hierarchy of storage resources to meet user needs while reducing overall storage management costs. The storage resources may be hierarchically organized based upon costs, speed, capacity, and other factors associated with the storage resources. For example, files may be migrated from online storage to near-line storage, from near-line storage to offline storage, and the like.

In storage environments where data is migrated, when a file located in an original storage location on an original storage unit is migrated, a portion (e.g., the data portion) of the file (or the entire file) is moved from the original storage location to another storage location (referred to as the “repository storage location” or “migration target repository”) that may be on some remote server. A stub file (or tag file) is usually left in place of the migrated file in the original storage location. The stub file serves as an entity in the original storage location that is visible to the user and/or applications and through which the user and/or applications can access the original file. Users and applications can access the migrated file as though the file was still stored in the original storage location. When a storage management application (e.g., HSM, ILM) receives a request to access the migrated file, the application determines the repository storage location of the migrated data corresponding to the stub file and recalls (or demigrates) the migrated file data from the repository storage location back to the original storage location.

The information stored in a stub file may vary in different storage environments. For example, in one embodiment, a stub file may store information that may be used by the storage management application to locate the migrated data. In certain embodiments, the information that is used to locate the migrated data may also be stored in a database rather than in the stub file, or in addition to the stub file. The migrated data may be remigrated from the repository storage location to another repository storage location. The stub file information and/or the database information may be updated to reflect the changed location of the migrated or remigrated data.

In other embodiments, a stub file may store attributes or metadata associated with the migrated file. The metadata may include information related to various attributes associated with the migrated file such as security attributes, file attributes, extended attributes, etc. In certain embodiments, the stub file may also store or cache a portion of the data portion of the file.

In conventional applications that migrate data, whenever a file operation such as a copy, move, or delete operation is performed on a migrated file, the migrated contents of the file are always recalled from the repository storage location to the original storage location on the original storage unit as part of the file operation. For example, for a move or copy operation, the migrated data is recalled back to the original storage location and the file is then copied or moved to some target location. Likewise, when a migrated file is to be deleted, the migrated data for the file is recalled from the repository storage location to the original storage location on the original storage unit before the file is then deleted. Accordingly, in conventional storage applications, whenever a move, copy, or delete operation or other file operations are performed on a migrated file, a recall operation is always performed.

Recall operations incur several detrimental overheads. Recall operations result in increased network traffic that may adversely affect the performance of the storage environment. A recall operation consumes valuable storage space on the original storage unit. This may be problematic if the storage units are experiencing a storage capacity problem. Further, a recall operation requires that the original storage unit that comprises the original storage location have enough storage space for storing the recalled data. If the requisite space is not available on the original storage unit, then the recall operation will fail and as a result the file operation that triggered the recall will also fail.

In light of the above, techniques are desired that reduce the number of recalls that are performed in a storage environment.

### BRIEF SUMMARY OF THE INVENTION

Embodiments of the present invention provide techniques for performing operations on migrated files without triggering a recall of the migrated data. For example, embodiments of the present invention can perform a copy, move, or delete operation on a migrated file without recalling the migrated data associated with the file.

According to an embodiment of the present invention, techniques are provided for performing an operation on a file. A request is received to perform a first operation on a first file located in a first storage location, wherein a portion of the first file has been migrated from the first storage location to a second storage location different from the first storage location. The first operation is performed on first file without recalling the migrated portion of the first file from the second storage location to the first storage location. Examples of first operations include copying the first file, moving the first file, deleting the first file, and the like.

According to another embodiment of the present invention, techniques are provided for copying a file. A request is received to copy a first file located in a first storage location to a target storage location, wherein a portion of the first file has been migrated from the first storage location to a second storage location different from the first storage location. A copy is made of the first file in the target storage location without recalling the migrated portion of the first file from the second storage location to the first storage location.

According to another embodiment of the present invention, techniques are provided for moving a file. A request is received to move a first file located in a first storage location to a target storage location, wherein a portion of the first file has been migrated from the first storage location to a second storage location different from the first storage location. The first file is moved from the first storage location to the target storage location without recalling the migrated portion of the first file from the second storage location to the first storage location.

According to another embodiment of the present invention, techniques are provided for deleting a file. A request is received to delete a first file located in a first storage location, wherein a portion of the first file has been migrated from the first storage location to a second storage location different from the first storage location. The first file is deleted from the first storage location without recalling the migrated portion of the first file from the second storage location to the first storage location.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a storage environment that may incorporate an embodiment of the present invention;

FIG. 2 is a simplified block diagram of a data processing system that maybe used to perform processing according to an embodiment of the present invention;

FIG. 3 is a simplified high-level flowchart depicting a method of copying a file without performing a recall according to an embodiment of the present invention;

FIG. 4 is a simplified high-level flowchart depicting a method of moving a file without performing a recall according to an embodiment of the present invention; and

FIG. 5 is a simplified high-level flowchart depicting a method of deleting a file without performing a recall according to an embodiment of the present invention.

### DETAILED DESCRIPTION OF THE INVENTION

In the following description, for the purposes of explanation, specific details are set forth in order to provide a thorough understanding of the invention. However, it will be apparent that the invention may be practiced without these specific details.

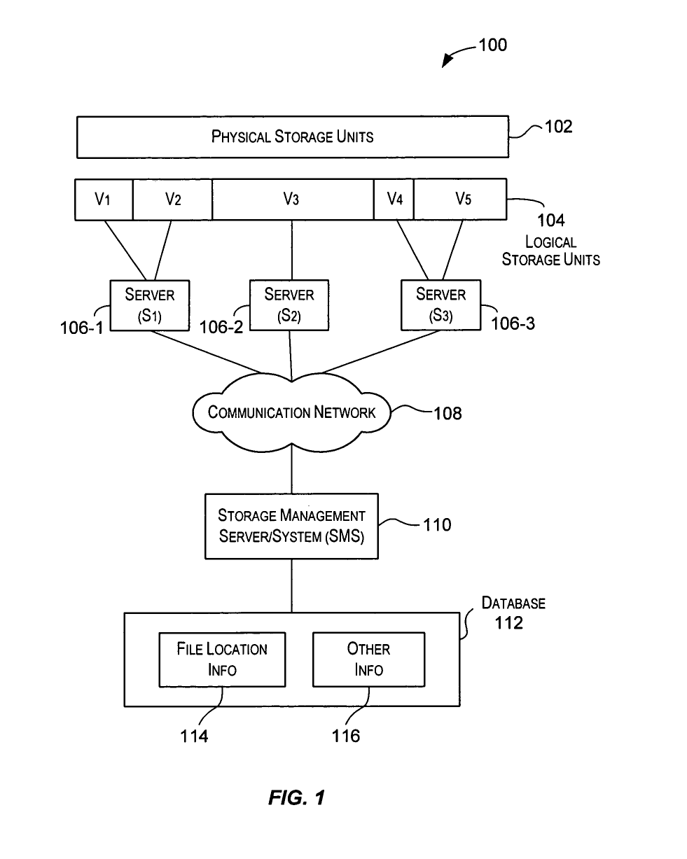

FIG. 1 is a simplified block diagram of a storage environment 100 that may incorporate an embodiment of the present invention. Storage environment 100 depicted in FIG. 1 is merely illustrative of an embodiment incorporating the present invention and does not limit the scope of the invention as recited in the claims. One of ordinary skill in the art would recognize other variations, modifications, and alternatives.

As depicted in FIG. 1, storage environment 100 comprises a plurality of physical storage devices or units 102 for storing data. Physical storage units 102 may include disk drives, tapes, hard drives, optical disks, RAID storage structures, solid state storage devices, SAN storage devices, NAS storage devices, and other types of devices and storage media capable of storing data. The term “physical storage unit” is intended to refer to any physical device, system, etc. that is capable of storing information or data.

Physical storage units 102 may be organized into one or more logical storage units 104 that provide a logical view of underlying disks provided by physical storage units 102. Each logical storage unit (e.g., a volume) is generally identifiable by a unique identifier (e.g., a number, name, etc.) that may be specified by the user. A single physical storage unit may be divided into several separately identifiable logical storage units. A single logical storage unit may span storage space provided by multiple physical storage units 102. A logical storage unit may reside on non-contiguous physical partitions. By using logical storage units, the physical storage units and the distribution of data across the physical storage units becomes transparent to servers and applications.

For purposes of description, logical storage units 104 are considered to be in the form of volumes. However, other types of logical storage units are also within the scope of the present invention. The term “storage unit” is intended to refer to a physical storage unit (e.g., a disk) or a logical storage unit (e.g., a volume).

Storage environment 100 also comprises several servers 106. Servers 106 may be data processing systems that are configured to provide a service. One or more volumes from logical storage units 104 may be assigned or allocated to servers 106. For example, as depicted in FIG. 1, volumes V1 and V2 are assigned to server (S1) 106-1, volume V3 is assigned to server (S2) 106-2, and volumes V4 and V5 are assigned to server (S3) 106-3. A server 106 provides an access point for the one or more volumes allocated to that server.

According to an embodiment of the present invention, a storage management server/system (SMS) 110 may be coupled to the storage resources and to servers 106 via communication network 108 (as shown in FIG. 1) or directly. Communication network 108 provides a mechanism for allowing communication between SMS 110 and servers 106. Communication network 108 may be a local area network (LAN), a wide area network (WAN), a wireless network, an Intranet, the Internet, a private network, a public network, a switched network, or any other suitable communication network. Communication network 108 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), Fiber Channel protocols, protocols under development by industry standard organizations, vendor-specific protocols, customized protocols, and others.

SMS 110 may be configured to execute applications that provide storage management services for storage environment 100. For example, storage management applications (e.g., HSM applications, ILM applications, etc.) that control migration and recall of data may be executed by SMS 110. The storage applications may also be executed by other servers. According to an embodiment of the present invention, SMS 110 is configured to execute an application or process that enables operations (e.g., copy, move, and delete) to be performed on files stored by the storage environment without performing a recall operation. The processing according to the teachings of the present invention may also be performed by servers 106, or by servers 106 in conjunction with SMS 110.

As depicted in FIG. 1, SMS 110 may have access to information that facilitates the performance of file operations without recalling data. As shown in FIG. 1, the information may be stored in database 112. The information stored in database 112 may include file location information 114 that comprises information related to files that have been migrated, recalled, etc. File location information 114 may be used to locate migrated data for files that have been migrated. File location information 114 or portions thereof may also be stored on or replicated in databases on servers 106. Database 112 may also store other information 116 that may include information related to storage policies and rules configured for the storage environment, information related to the various monitored storage units, information related to the files stored in the storage environment, and the like. Database 112 may be embodied in various forms including a relational database, directory services, data structure, etc. The information may be stored in various formats.

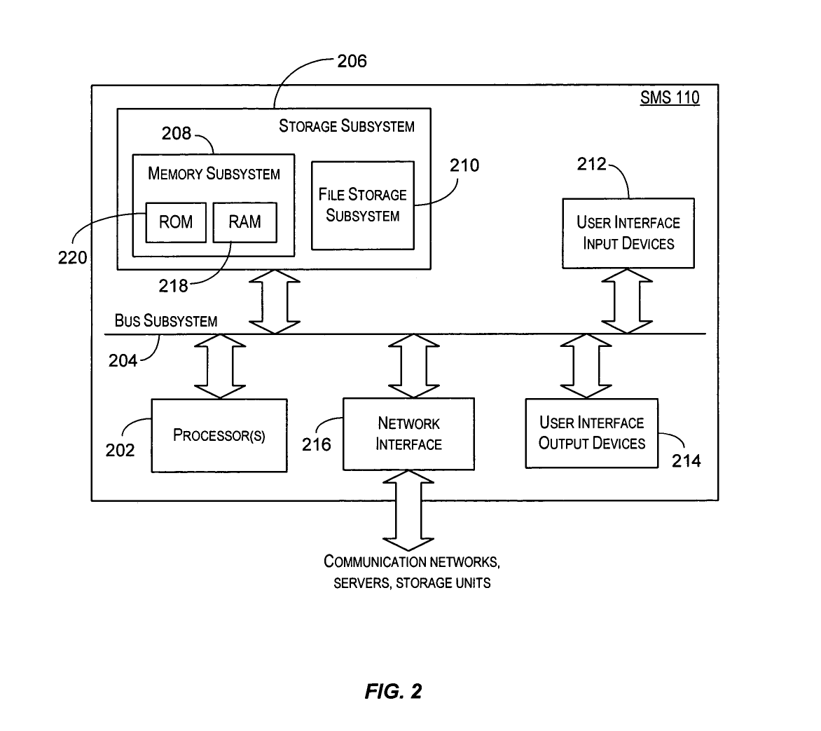

FIG. 2 is a simplified block diagram of SMS 110 (or any data processing system) that may be used to perform processing according to an embodiment of the present invention. As shown in FIG. 2, SMS 110 includes a processor 202 that communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow a user, such as the administrator, to interact with SMS 110.

Network interface subsystem 216 provides an interface to other computer systems, networks, servers, and storage units. Network interface subsystem 216 serves as an interface for receiving data from other sources and for transmitting data to other sources from SMS 110. Embodiments of network interface subsystem 216 include an Ethernet card, a modem (telephone, satellite, cable, ISDN, etc.), (asynchronous) digital subscriber line (DSL) units, and the like.

User interface input devices 212 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to SMS 110.

User interface output devices 214 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from SMS 110.

Storage subsystem 206 may be configured to store the basic programming and data constructs that provide the functionality of the present invention. For example, according to an embodiment of the present invention, software code modules (or instructions) implementing the functionality of the present invention may be stored in storage subsystem 206. These software modules or instructions may be executed by processor(s) 202. Storage subsystem 206 may also provide a repository for storing data used in accordance with the present invention. For example, information used for enabling operations to be performed on files without performing recalls may be stored in storage subsystem 206. Storage subsystem 206 may also be used as a migration repository to store data that is moved from a storage unit. Storage subsystem 206 may also be used to store data that is moved from another storage unit. Storage subsystem 206 may comprise memory subsystem 208 and file/disk storage subsystem 210.

Memory subsystem 208 may include a number of memories including a main random access memory (RAM) 218 for storage of instructions and data during program execution and a read only memory (ROM) 220 in which fixed instructions are stored. File storage subsystem 210 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 204 provides a mechanism for letting the various components and subsystems of SMS 110 communicate with each other as intended. Although bus subsystem 204 is shown schematically as a single bus, alternative embodiments of the bus subsystem may utilize multiple busses.

SMS 110 can be of various types including a personal computer, a portable computer, a workstation, a network computer, a mainframe, a kiosk, or any other data processing system. Due to the ever-changing nature of computers and networks, the description of SMS 110 depicted in FIG. 2 is intended only as a specific example for purposes of illustrating the preferred embodiment of the computer system. Many other configurations having more or fewer components than the system depicted in FIG. 2 are possible.

Servers 106 and SMS 100 facilitate migration, remigration, and recall operations for files stored by storage units of storage environment 100. According to an embodiment of the present invention, servers 106 and SMS 100 enable file operations to be performed on the migrated files without triggering a recall. The following notations will be used in this application to facilitate discussion of the present invention. These notations are not intended to limit the scope of the present invention as recited in the claims.

An “original storage location” is a storage location (e.g., a directory) where a file is stored before the file is migrated.

An “original storage unit” is a storage unit that comprises the original storage location. An “original volume” is a volume comprising the original storage location.

An “original server” is a server to which the original storage unit or original volume is allocated. The original server may be configured to manage access to the original storage unit or volume.

A “repository storage location” is a storage location (e.g., a directory) where the migrated or remigrated data from a migrated file is stored.

A “repository storage unit” is a storage unit on which the repository storage location is located. A “repository volume” is a volume on which the repository storage location is located.

A “repository server” is a server to which the repository storage unit or repository volume is allocated. The repository server may be configured to manage access to the repository storage unit or volume.

A “target storage location” is a storage location to which a file is to be moved or copied.

A “target storage unit” is a storage unit that comprises the target storage location. A “target volume” is a volume comprising the target storage location.

Migration is a process or operation where a portion (or even the entire file) of the file being migrated is moved from an original storage location on an original volume where the file is stored to a repository storage location on a repository volume. The migrated portion of the file may include, for example, the data portion of the file. In certain embodiments, the migrated portion of the file may also include a portion of (or the entire) metadata associated with the file. The metadata may comprise attributes such as security attributes (e.g., ownership information, permissions information, access control lists, etc.), file attributes (e.g., file size, file creation information, file modification information, access time information, etc.), extended attributes (attributes specific to certain file systems, e.g., subject information, title information), sparse attributes, alternate streams, etc. associated with the file.

As a result of migration, a stub or tag file may be left in place of the original file in the original storage location on the original volume. The stub file is a physical file that serves as an entity in the original storage location that is visible to the user and/or applications and through which the user and/or applications can access the original file. Users and applications can access the migrated file as though the file was still stored in the original storage location using the stub file. When a storage management application (e.g., HSM, ILM) receives a request to access the migrated file, the application determines the repository storage location of the migrated data corresponding to the stub file and recalls (or demigrates) the migrated file data from the repository storage location back to the original storage location. The location of the migrated data may be determined from a database storing information for migrated files. For example, the information may be stored in a database such as database 112 depicted in FIG. 1 as part of file location information 114. In some embodiments, the location may also be determined from information stored in the stub file.

The information stored in a stub file may vary in different storage environments. For example, in one embodiment, a stub file may store information that may be used by the storage management application to locate the migrated data. In some embodiments, a stub file may store attributes or metadata associated with the migrated file. The metadata may include information related to various attributes associated with the migrated file such as security attributes, file attributes, extended attributes, etc. In certain embodiments, the stub file may also store or cache a portion of the data portion of the file.

In some embodiments, as a result of migration, information related to the migrated files such as information identifying the original volume, the repository volume, information identifying the repository storage location, etc. may also be stored in a centralized location. For example, the information may be stored in a database such as database 112 depicted in FIG. 1 as part of file location information 114.

A recall operation is an operation in which the migrated portion of a file is recalled or moved from the repository storage location (on the repository storage unit) back to the original storage location on the original storage unit. A recall is usually performed when a request is received to access a migrated file. According to one embodiment, as part of the recall operation, the original server identifies the repository server from information stored in the stub file (or from information stored in a database such as file location information 114 depicted in FIG. 1) corresponding to file to be recalled. The migrated data is then recalled from the repository storage location on the repository volume to the original storage location on the original volume.

According to the teachings of the present invention, file operations, which would conventionally trigger a recall, are performed for migrated files without triggering a recall operation for the file. Examples of such operations include copying a migrated file, moving a migrated file, deleting a migrated file, etc. In general, the teachings of the present invention may be applied to any file operation that would trigger a recall.

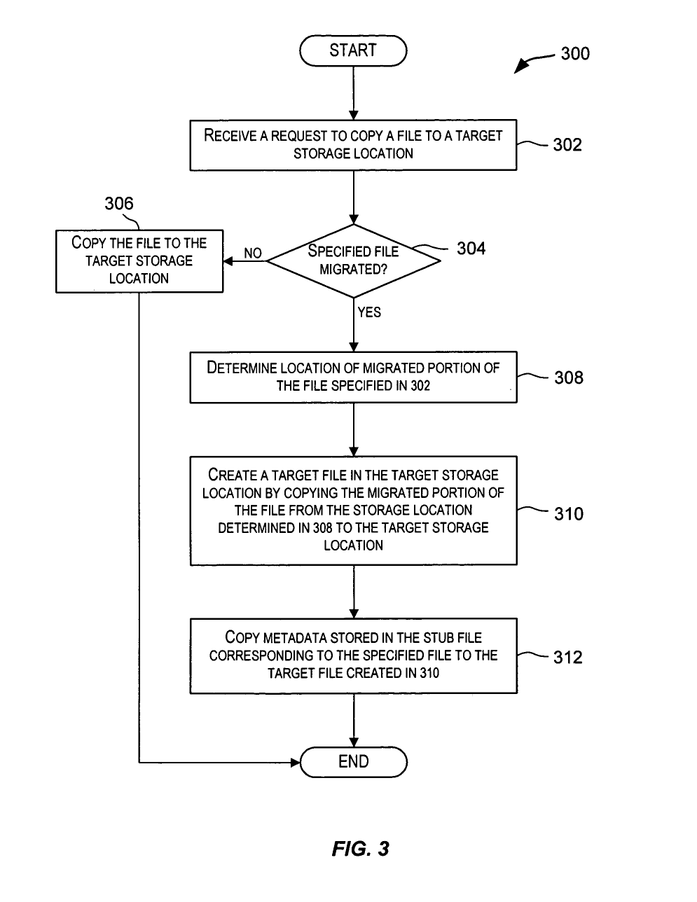

FIG. 3 is a simplified high-level flowchart 300 depicting a method of copying a file without performing a recall according to an embodiment of the present invention. The method depicted in FIG. 3 may be performed by software modules executed by a processor, hardware modules, or combinations thereof. Flowchart 300 depicted in FIG. 3 is merely illustrative of an embodiment of the present invention and is not intended to limit the scope of the present invention. Other variations, modifications, and alternatives are also within the scope of the present invention. The method depicted in FIG. 3 may be adapted to work with different implementation constraints.

As depicted in FIG. 3, processing is initiated upon receiving a request to copy a file to a target storage location (e.g., a target directory) (step 302). The target storage location may be on the same storage unit (e.g., same volume) as where the file is originally stored or on a different storage unit. The request may be received responsive to a user action (e.g., the user requests the file to be copied) or may be received from an application or process (e.g., an application that is configured to perform file operations, etc.), etc.

A determination is then made if the specified file to be copied has been migrated (step 304). The determination may be made using several techniques. According to one technique, if a stub file is located in place of the actual file in the original storage location, then this indicates that the file has been migrated. According to another technique, information stored for migrated files (e.g., file location information 114 stored in database 112) may be queried to determine if the specified file to be copied has been migrated.

If it is determined in 304 that the file has not been migrated, then the file is copied to the specified target storage location (step 306) and this completes the file copy operation. Since the file has not been migrated, no recall operation needs to be performed.

If it is determined in step 304 that the file has been migrated, then the location of the migrated portion of the file to be copied is determined (step 308). As part of 308, the repository storage location and the repository storage unit (e.g., the repository volume) may be determined. In one embodiment, the location of the migrated portion of the file may be determined from information stored in a stub file located in the original storage location in place of the file to be copied. The location of the migrated file data may also be determined from file location information 114 stored in database 112. In certain embodiments, information in the stub file and the file location information may be used in conjunction to determine the location of the migrated file data.

A target file is then created in the target storage location by copying the migrated portion of the specified file from the repository storage location determined in step 308 to the specified target storage location (step 310). The migrated portion of the file may comprise the data portion of the file. In some embodiments, the migrated data may also include metadata associated with the file, and the metadata is also copied to the target file in 310.

Metadata stored in the stub file corresponding to the file to be copied may then be copied to the target file created in 310 (step 312). The metadata associated with the stub file may include attributes such as security attributes (e.g., ownership information, permissions information, access control lists, etc.), file attributes (e.g., file size, file creation information, file modification information, access time information, etc.), extended attributes (attributes specific to certain operating systems, e.g., subject information, title information), sparse attributes, alternate streams, etc. associated with the file. After 312, the target file is the recreation of the specified file prior to the migration and thus is a copy of the specified file. Step 312 may not be performed if the metadata associated with the file has already been copied to the target file in 310.

According to an embodiment of the present invention, in 312, for security attributes associated with the stub file, only the non-inherited security attributes are applied to the target file. For example, a file may inherit security attributes (e.g., read, write, view attributes) from the directory in which the file is located or from the directory structure in which the file is located. Such inherited security attributes are not copied or applied to the target file as they are not attributes that are native to the file.

The file copy operation is completed after completion of step 312. As described above, the copying of the migrated file is achieved without triggering a recall. In this manner, the problems associated with recalls such as increased network traffic that can degrade the performance of the storage environment are avoided. Further, copy operations may be successfully performed even if the original storage unit does not have sufficient storage capacity to store the recalled file data.

Various measures may be used to preserve the consistency of the file system due to errors that may occur during the copy operation described above. For example, at the start of the copy operation, the status of the file may be marked as “copy in progress”. The original file may be saved in memory for rollback purposes in case or errors that may occur. If an error occurs during the copy operation, then the file status for the original file may be rolled back to its original status and the stub file and the migrated data in the repository storage location are left unchanged.

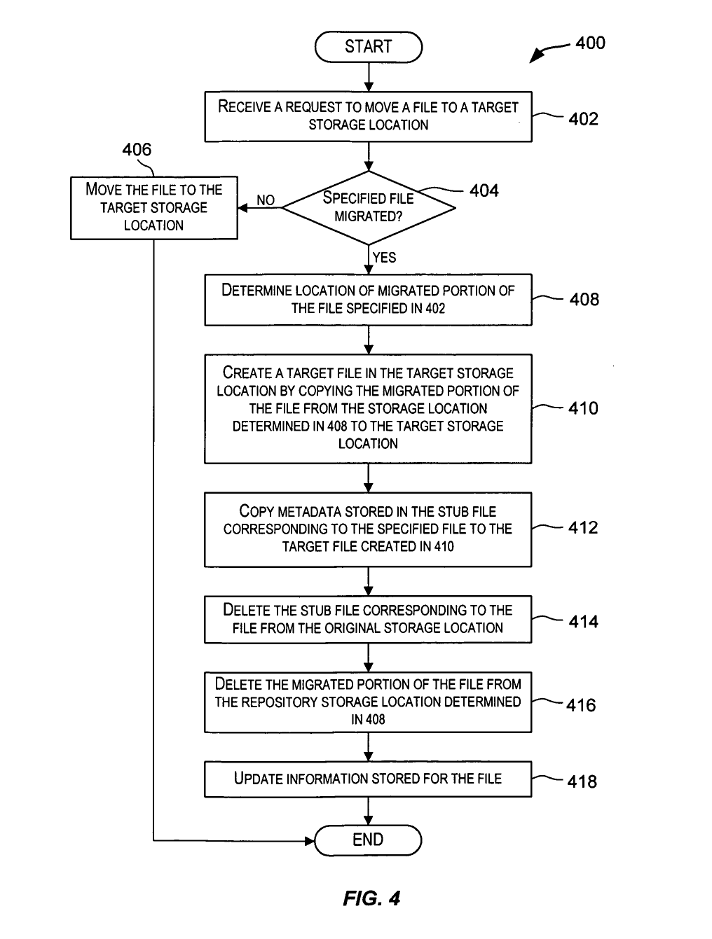

FIG. 4 is a simplified high-level flowchart 400 depicting a method of moving a file without performing a recall according to an embodiment of the present invention. The method depicted in FIG. 4 may be performed by software modules executed by a processor, hardware modules, or combinations thereof. Flowchart 400 depicted in FIG. 4 is merely illustrative of an embodiment of the present invention and is not intended to limit the scope of the present invention. Other variations, modifications, and alternatives are also within the scope of the present invention. The method depicted in FIG. 4 may be adapted to work with different implementation constraints.

As depicted in FIG. 4, processing is initiated upon receiving a request to move a file from its current location to a target storage location (e.g., a target directory) (step 402). The target storage location may be on the same storage unit (e.g., same volume) as where the file is presently stored or on a different storage unit. The request may be received responsive to a user action (e.g., the user requests the file to be moved), or may be received from an application or process (e.g., an application that is configured to perform backup operations, etc.), etc.

A determination is then made if the specified file to be moved has been migrated (step 404). As previously described, such a determination may be made using several techniques. For example, if a stub file is located in place of the file, then this indicates that the file has been migrated. Alternatively, information stored for the migrated files (e.g., file location information 114 stored in database 112) may be queried to determine if the specified file to be moved has been migrated.

If it is determined in 404 that the specified file has not been migrated, then the file is moved to the specified target storage location (step 406) and this completes the file move operation. Since the file has not been migrated, no recall operation needs to be performed as a result of the move operation.

If it is determined in step 404 that the specified file has been migrated, then the location of the migrated portion of the file to be moved is determined (step 408). As part of 408, the repository storage location and the repository storage unit (e.g., the repository volume) may be determined. As previously described, the location of the migrated portion of the file to be moved may be determined from information stored in a stub file located in the original storage location in place of the specified file to be moved. The location of the migrated file portion may also be determined from file location information 114 stored in database 112. In some embodiments, information in the stub file and the file location information may be used in conjunction to determine the location of the migrated file data.

A target file is then created in the target storage location by copying the migrated file portion of the specified file from the repository storage location determined in step 408 to the specified target storage location (step 410). The migrated portion of the file may comprise the data portion of the file. In some embodiments, the migrated data may also include metadata associated with the file, and the metadata is also copied to the target file in 410.

Metadata stored in the stub file corresponding to the specified file may then be copied to the target file created in 410 (step 412). As previously stated, the metadata associated with the stub file may include attributes such as security attributes (e.g., ownership information, permissions information, access control lists, etc.), file attributes (e.g., file size, file creation information, file modification information, access time information, etc.), extended attributes (attributes specific to certain operating systems, e.g., subject information, title information), sparse attributes, alternate streams, etc. associated with the file. After 412, the target file is the recreation of the specified file prior to the migration and thus is a copy of the specified file. Step 412 may not be performed if the metadata associated with the file has already been copied to the target file in 410.

According to an embodiment of the present invention, in 412, for security attributes associated with the stub file, only the non-inherited security attributes are applied to the target file. For example, a file may inherit security attributes (e.g., read, write, view attributes) from the directory in which the file is located or from the directory structure in which the file is located. Such inherited security attributes are not applied to the target file as they are not attributes that are native to the file.

The stub file corresponding to the specified file is then deleted from the original storage location (step 414). The migrated portion of the specified file is deleted from the repository storage location (step 416). If information is stored for migrated files (e.g., file location information 114 in database 112), then the information stored for the specified file is updated to reflect that the stub file and the migrated portion of the specified original file have been deleted (step 418). As part of 418, the file entry in the database may be marked as inactive.

As described above, a migrated file is moved to the specified target storage location without triggering a recall. In this manner, the problems associated with recalls such as increased network traffic that can degrade the performance of the storage environment are avoided. Move operations may be successfully performed even if the original storage unit does not have sufficient storage capacity to store the recalled file data. Further, the requisite databases storing file information are appropriately updated to maintain consistency of the file system.

Various measures may be used to preserve the consistency of the file system due to errors that may occur during the move operation depicted in FIG. 4. For example, at the start of the move operation, the status of the file may be marked as “move in progress”. The original file may be saved in memory for rollback purposes in case or errors that may occur. If any errors occur before the stub file and the migrated data in the repository storage location are deleted, the file status for the original file is rolled back to its original status and the stub file in the original storage location and the migrated data in the repository storage location are left unchanged. If an error occurs after the stub file is deleted but before the repository file data is deleted, the file status for the original file in the database is marked to indicate “pending deleting repository file data”. A background thread then processes this record and deletes the orphaned repository file data. The file location record saved in the database is updated by the background process to reflect the fact that the repository file is deleted.

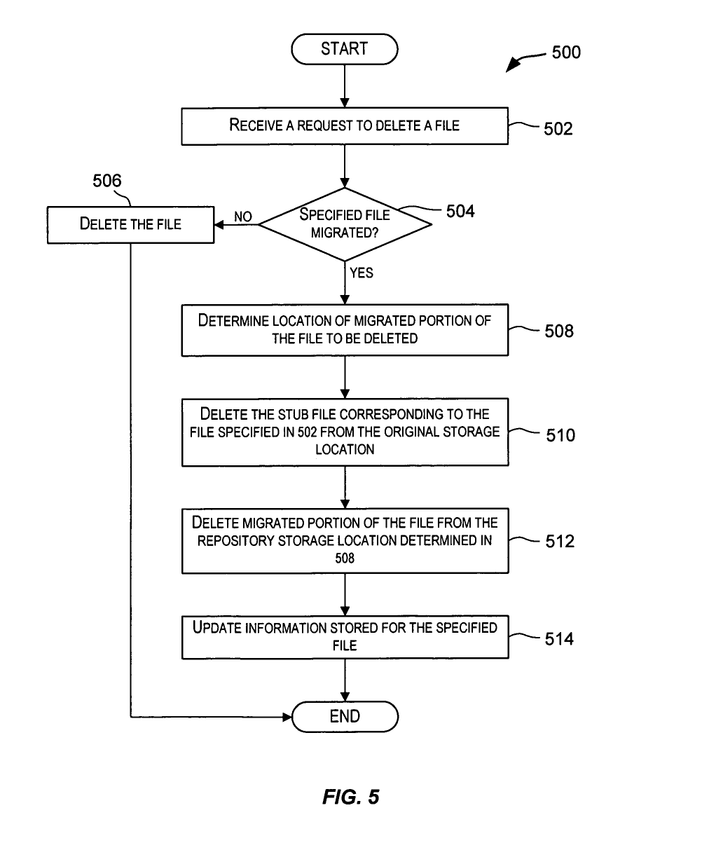

FIG. 5 is a simplified high-level flowchart 500 depicting a method of deleting a file without performing a recall according to an embodiment of the present invention. The method depicted in FIG. 5 may be performed by software modules executed by a processor, hardware modules, or combinations thereof. Flowchart 500 depicted in FIG. 5 is merely illustrative of an embodiment of the present invention and is not intended to limit the scope of the present invention. Other variations, modifications, and alternatives are also within the scope of the present invention. The method depicted in FIG. 5 may be adapted to work with different implementation constraints.

As depicted in FIG. 5, processing is initiated upon receiving a request to delete a file (step 502). The request may be received responsive to a user action (e.g., the user requests the file to be deleted) or may be received from an application or process.

A determination is then made if the specified file to be deleted has been migrated (step 504). As previously described, such a determination may be made using several techniques. For example, if a stub file is located in place of the actual file, then this indicates that the file has been migrated. Alternatively, information stored for the migrated files (e.g., file location information 114 stored in database 112) may be queried to determine if the specified file to be moved has been migrated.

If it is determined in 504 that the specified file has not been migrated, then the file is deleted (step 506) and this completes the file delete operation. Since the file has not been migrated, no recall operation needs to be performed as a result of the delete operation.

If it is determined in step 504 that the specified file has been migrated, then the location of the migrated portion of the file to be deleted is determined (step 508). As part of 508, the repository storage location and the repository storage unit (e.g., the repository volume) may be determined. As previously described, the location of the migrated file data may be determined from information stored in a stub file corresponding to the specified file to be deleted which is stored in the original storage location of the specified file. The location of the migrated portion of the file may also be determined from file location information 114 stored in database 112. In some embodiments, information in the stub file and the file location information may be used in conjunction to determine the location of the migrated file portion.

A stub file corresponding to the specified file is then deleted from the original storage location (step 510). The migrated file portion is then deleted from the repository storage location determined in step 508 (step 512). If file information is stored for migrated files (e.g., file location information 114 in database 112), then the stored information for the specified file is updated to reflect the deletion of the stub file and the migrated file portion (step 514).

As described above, a migrated file is deleted without triggering a recall. In this manner, problems associated with recalls such as increased network traffic that can degrade the performance of the storage environment are avoided. Delete operations may be successfully performed even if the original storage unit does not have sufficient storage capacity to store the recalled file data. Further, the requisite databases storing file information are appropriately updated to maintain consistency of the file system.

Various measures may be used to preserve the consistency of the file system due to errors that may occur during the delete operation. For example, at the start of the delete operation, the status of the file may be marked as “delete in progress”. The original file may be saved in memory for rollback purposes in case or errors that may occur. If any errors occur before the stub file and the migrated data in the repository storage location are deleted, the file status for the original file is rolled back to its original status and the stub file and the migrated data in the repository storage location are left unchanged. If an error occurs after the stub file is deleted but before the repository file data is deleted, the file status for the original file in the database is marked to indicate “pending deleting repository file data”. A background thread then processes this record and deletes the orphaned repository file data. The file location record saved in the database is updated by the background process to reflect the fact that the repository file is deleted.

As described above, embodiments of the present invention perform file operations on migrated files such as moving a file, copying a file, and deleting a file without triggering a recall. These operations are accordingly performed without burdening network traffic. Further, lack of sufficient space on the original storage unit to store the recalled migrated data does not cause the file operations to fail. This is particularly useful in storage environments with large file sizes.

The techniques described above can be used in any storage environment where portions of a file (e.g., the data portion) or the entire file are moved or migrated from the original location of the file to some other location. Examples of such storage environments include environments managed by HSM applications, by ILM applications, and the like. In such storage environments, embodiments of the present invention can be used to perform file operations on migrated files without triggering a recall. Embodiments of the present invention thus improve the efficiency of file operations that are performed in such storage environments while preserving consistency of the file system.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

1. A computer-implemented method of copying a file, the method comprising:
receiving a request to copy a first file located in a first storage location to a target storage location, wherein a portion of the first file has been migrated from the first storage location to a second storage location different from the first storage location; and
making a copy of the first file in the target storage location without recalling the migrated portion of the first file from the second storage location to the first storage location.

2. The method of claim 1 wherein a stub file is located in the first storage location in place of the first file and wherein making the copy of the first file comprises:
determining the second storage location where the migrated portion of the first file is stored;
copying the migrated portion of the first file from the second storage location to the target storage location to create a target file; and
copying a portion of data stored in the stub file to the target file.

3. The method of claim 2 wherein the data stored in the stub file comprises at least one of security attributes, file attributes, and extended attributes.

4. The method of claim 1 further comprising determining that the portion of the first file has been migrated from the first storage location.

5. A computer-implemented method of moving a file, the method comprising:
receiving a request to move a first file located in a first storage location to a target storage location, wherein a portion of the first file has been migrated from the first storage location to a second storage location different from the first storage location; and
moving the first file from the first storage location to the target storage location without recalling the migrated portion of the first file from the second storage location to the first storage location.

6. The method of claim 5 wherein a stub file is located in the first storage location in place of the first file and wherein moving the first file comprises:
determining the second storage location where the migrated portion of the first file is stored;
copying the migrated portion of the first file from the second storage location to the target storage location to create a target file;
copying a portion of data stored in the stub file to the target file;
deleting the stub file in the first storage location; and
deleting the migrated portion in the second storage location.

7. The method of claim 6 wherein the data stored in the stub file comprises at least one of security attributes, file attributes, and extended attributes.

8. The method of claim 6 further comprising:
providing a database storing information related to files whose portions have been migrated, the information comprising information for the first file; and
updating the information for the first file to reflect deletion of the stub file and the migrated portion of the first file.

9. A computer-implemented method of deleting a file, the method comprising:
receiving a request to delete a first file located in a first storage location, wherein a portion of the first file has been migrated from the first storage location to a second storage location different from the first storage location; and
deleting the first file from the first storage location without recalling the migrated portion of the first file from the second storage location to the first storage location.

10. The method of claim 9 wherein a stub file is located in the first storage location in place of the first file and wherein deleting the first file comprises:
determining the second storage location where the migrated portion of the first file is stored;
deleting the stub file located in the first storage location; and
deleting the migrated portion of the first file located in the second storage location.

11. The method of claim 10 further comprising:
providing a database storing information related to files whose portions have been migrated, the information comprising information for the first file; and
updating the information for the first file to reflect deletion of the stub file and the migrated portion of the first file.

12. A computer-implemented method of performing an operation on a file, the method comprising:
receiving a request to perform a first operation on a first file located in a first storage location, wherein a portion of the first file has been migrated from the first storage location to a second storage location different from the first storage location; and
performing the first operation on first file without recalling the migrated portion of the first file from the second storage location to the first storage location.

13. The method of claim 12 wherein the first operation is to make a copy of the first file in a target storage location.

14. The method of claim 12 wherein the first operation is to move the first file from the first storage location to a target storage location.

15. The method of claim 12 wherein the first operation is to delete the first file from the first storage location.

16. A computer program product stored on a computer-readable medium for copying a file, the computer program product comprising:
code for receiving a request to copy a first file located in a first storage location to a target storage location, wherein a portion of the first file has been migrated from the first storage location to a second storage location different from the first storage location; and
code for making a copy of the first file in the target storage location without recalling the migrated portion of the first file from the second storage location to the first storage location.

17. The computer program product of claim 16 wherein a stub file is located in the first storage location in place of the first file and wherein the code for making the copy of the first file comprises:
code for determining the second storage location where the migrated portion of the first file is stored;
code for copying the migrated portion of the first file from the second storage location to the target storage location to create a target file; and
code for copying a portion of data stored in the stub file to the target file.

18. The computer program product of claim 17 wherein the data stored in the stub file comprises at least one of security attributes, file attributes, and extended attributes.

19. A computer program product stored on a computer-readable medium for moving a file, the computer program product comprising:
code for receiving a request to move a first file located in a first storage location to a target storage location, wherein a portion of the first file has been migrated from the first storage location to a second storage location different from the first storage location; and
code for moving the first file from the first storage location to the target storage location without recalling the migrated portion of the first file from the second storage location to the first storage location.

20. The computer program product of claim 19 wherein a stub file is located in the first storage location in place of the first file and wherein the code for moving the first file comprises:
code for determining the second storage location where the migrated portion of the first file is stored;
code for copying the migrated portion of the first file from the second storage location to the target storage location to create a target file;
code for copying a portion of data stored in the stub file to the target file;
code for deleting the stub file in the first storage location; and
code for deleting the migrated portion in the second storage location.

21. The computer program product of claim 20 wherein the data stored in the stub file comprises at least one of security attributes, file attributes, and extended attributes.

22. The computer program product of claim 20 further comprising:
code for providing a database storing information related to files whose portions have been migrated, the information comprising information for the first file; and
code for updating the information for the first file to reflect deletion of the stub file and the migrated portion of the first file.

23. A computer program product stored on a computer-readable medium for deleting a file, the computer program product comprising:
code for receiving a request to delete a first file located in a first storage location, wherein a portion of the first file has been migrated from the first storage location to a second storage location different from the first storage location; and
code for deleting the first file from the first storage location without recalling the migrated portion of the first file from the second storage location to the first storage location.

24. The computer program product of claim 23 wherein a stub file is located in the first storage location in place of the first file and wherein the code for deleting the first file comprises:
code for determining the second storage location where the migrated portion of the first file is stored;
code for deleting the stub file located in the first storage location; and
code for deleting the migrated portion of the first file located in the second storage location.

25. The computer program product of claim 24 further comprising:
code for providing a database storing information related to files whose portions have been migrated, the information comprising information for the first file; and
code for updating the information for the first file to reflect deletion of the stub file and the migrated portion of the first file.

26. A computer program product stored on a computer-readable medium for performing an operation on a file, the computer program product comprising:
code for receiving a request to perform a first operation on a first file located in a first storage location, wherein a portion of the first file has been migrated from the first storage location to a second storage location different from the first storage location; and
code for performing the first operation on first file without recalling the migrated portion of the first file from the second storage location to the first storage location.

27. The computer program product of claim 26 wherein the first operation is to make a copy of the first file in a target storage location.

28. The computer program product of claim 26 wherein the first operation is to move the first file from the first storage location to a target storage location.

29. The computer program product of claim 26 wherein the first operation is to delete the first file from the first storage location.

30. A storage management system comprising:
a first storage unit;
a second storage unit; and
a data processing system;
wherein the data processing system is configured to:
receive a request to perform a first operation on a first file located on the first storage unit, wherein a portion of the first file has been migrated from the first storage unit to the second storage unit; and
perform the first operation on first file without recalling the migrated portion of the first file from the second storage unit to the first storage unit.

31. The system of claim 30 wherein the first operation is to make a copy of the first file in a target storage location.

32. The system of claim 30 wherein the first operation is to move the first file from the first storage location to a target storage location.

33. The system of claim 30 wherein the first operation is to delete the first file from the first storage location.

34. An apparatus for performing operations on files, the apparatus comprising:
means for receiving a request to perform a first operation on a first file located in a first storage location, wherein a portion of the first file has been migrated from the first storage location to a second storage location different from the first storage location; and
means for performing the first operation on first file without recalling the migrated portion of the first file from the second storage location to the first storage location.

35. The apparatus of claim 34 wherein the first operation is at least one of an operation to make a copy of the first file in a target storage location, an operation to move the first file from the first storage location to a target storage location, and an operation to delete the first file from the first storage location
